(19) United States
(12) Patent Application Publication
(10) Pub. No.: US 2015/0107306 A1
(43) Pub. Date: Apr. 23, 2015

(54) APPARATUS AND METHODS FOR PRODUCING GLASS RIBBON

(71) Applicant: Corning Incorporated, Corning, NY (US)

(72) Inventors: Martin Herbert Goller, Campbell, NY (US); James Patrick Murphy, Corning, NY (US)

(73) Assignee: Corning Incorporated, Corning, NY (US)

(21) Appl. No.: 14/057,639

(22) Filed: Oct. 18, 2013

(51) Int. Cl. C03B 5/225

(52) U.S. Cl. CPC C03B 5/225
USPC 65/135.1; 65/346

(57) ABSTRACT

An apparatus for producing glass ribbon comprises a melting vessel configured to melt a batch of material into a quantity of molten glass. The apparatus includes a cooling conduit with a peripheral wall comprising platinum and defining an interior pathway configured to provide a travel path for the quantity of molten glass traveling from the first conditioning station to the second conditioning station. The peripheral wall includes an outer surface defining a plurality of elongated radial peaks spaced apart by a plurality of elongated radial valleys. The elongated radial peaks and elongated radial valleys are helically wound along an elongated axis of the cooling conduit. In further examples, methods are provided with the step of passing molten glass through the interior pathway of the cooling conduit to pass the molten glass from the first conditioning station to the second conditioning station.

### TECHNICAL FIELD

The present invention relates generally to apparatus and methods for producing glass ribbon and, more particularly, to apparatus and methods for producing glass ribbon with a cooling conduit including radial valleys helically wound along an elongated axis of the cooling conduit.

### BACKGROUND

Glass manufacturing apparatus are commonly used to form various glass products such as LCD sheet glass. It is known to manufacture sheet glass with an apparatus including a conduit operably connecting a first conditioning station with a second conditioning station.

### SUMMARY

The following presents a simplified summary of the disclosure in order to provide a basic understanding of some example aspects described in the detailed description.

In a first aspect of the disclosure, an apparatus for producing glass ribbon comprises a melting vessel configured to melt a batch of material into a quantity of molten glass. The apparatus further includes at least a first conditioning station positioned downstream from the melting vessel and a second conditioning station positioned downstream from the first conditioning station. The apparatus still further includes a cooling conduit operably connecting the first conditioning station with the second conditioning station. The cooling conduit includes a peripheral wall comprising platinum and defining an interior pathway configured to provide a travel path for the quantity of molten glass traveling from the first conditioning station to the second conditioning station. The peripheral wall includes an outer surface defining a plurality of elongated radial peaks spaced apart by a plurality of elongated radial valleys. The elongated radial peaks and elongated radial valleys are helically wound along an elongated axis of the cooling conduit.

In one example of the first aspect, the peripheral wall defining the interior pathway includes a thickness defining the plurality of elongated radial peaks and elongated radial valleys.

In another example of the first aspect, the thickness of the peripheral wall is within a range of from about 500 microns to about 800 microns.

In still another example of the first aspect, the peripheral wall includes a thickness within a range of from about 500 microns to about 800 microns.

In still another example of the first aspect, the elongated radial peaks and the elongated radial valleys define a stepped peripheral contour circumscribing the elongated axis of the cooling conduit.

In still another example of the first aspect, the elongated radial peaks and the elongated radial valleys define a curvilinear peripheral contour circumscribing the elongated axis of the cooling conduit.

In still another example of the first aspect, the curvilinear peripheral contour comprises a sinusoidal peripheral contour.

In still another example of the first aspect, a fluid cooling device configured to force cooling fluid over the outer surface of the peripheral wall. In one example, the fluid cooling device comprises a housing configured circumscribe the outer surface of the peripheral wall of the cooling conduit. In one particular example, an inner surface of the housing is spaced from the elongated radial peaks and the elongated radial valleys of the outer surface. In another particular example, helical fluid cooling paths are defined by the elongated radial valleys being capped by an inner surface of the housing. In another example, the fluid cooling device is configured to provide a plurality of independent cooling zones located along the axis of the cooling conduit.

The first aspect may be provided alone or in combination with one or any combination of the examples of the first aspect discussed above.

In a second aspect of the disclosure a method of producing glass ribbon comprises the step (I) of providing a first conditioning station positioned downstream from a melting vessel and a second conditioning station positioned downstream from the first conditioning station. A cooling conduit operably connects the first conditioning station with the second conditioning station, wherein the cooling conduit includes a peripheral wall comprising platinum and defining an interior pathway. An outer surface of the peripheral wall defines a plurality of elongated radial peaks spaced apart by a plurality of elongated radial valleys, with the elongated radial peaks and elongated radial valleys helically wound along an elongated axis of the cooling conduit. The method further includes the step (II) of melting batch material with the melting vessel to produce a quantity of molten glass. The method further includes the step (III) of passing the molten glass through the interior pathway of the cooling conduit to pass the molten glass from the first conditioning station to the second conditioning station. The method also includes the step (IV) of fluid cooling the outer surface of the peripheral wall of the cooling conduit to cool the quantity of molten glass during step (III).

In one example of the second aspect, step (IV) includes forcing cooling fluid over the outer surface of the peripheral wall of the cooling conduit with a fluid cooling device. For example, the method can further comprise providing the fluid cooling device with a housing that circumscribes the outer surface of the peripheral wall of the cooling conduit. In one particular example, the housing may be provided with an inner surface that is spaced from the elongated radial peaks and the elongated radial valleys of the outer surface. In another particular example, the method further comprises the step of forming helical fluid cooling paths by capping the elongated radial valleys with an inner surface of the housing, wherein step (IV) includes forcing cooling fluid through the helical fluid cooling paths to cool the quantity of molten glass. In another example, the method includes independently cooling a plurality of cooling zones located along the axis of the cooling conduit at different cooling rates.

In another example of the second aspect, the peripheral wall of the cooling conduit is provided with a thickness within a range of from about 500 microns to about 800 microns.

In another example of the second aspect, the elongated radial peaks and the elongated radial valleys define peripheral cross-sectional contour circumscribing the elongated axis of the cooling conduit with a shape selected from the group consisting of: a stepped shape and a curvilinear shape.

The second aspect may be provided alone or in combination with one or any combination of the examples of the second aspect discussed above.

### BRIEF DESCRIPTION OF THE DRAWINGS

These and other aspects are better understood when the following detailed description is read with reference to the accompanying drawings, in which:

FIG. 1 is a schematic view of an example apparatus for producing glass ribbon;

FIG. 2 is an enlarged partial perspective cross-sectional view of the apparatus along line 2-2 of FIG. 1;

FIG. 3 illustrates a cross-sectional view of a conduit in accordance with aspects of the disclosure;

FIG. 4 illustrates cross-sectional perspective view of the conduit of FIG. 3;

FIG. 5 illustrates an enlarged view of a cross-sectional profile of the conduit at view 5 of FIG. 3;

FIG. 6 illustrates another enlarged view of an alternative cross-sectional profile of the conduit;

FIG. 7 illustrates yet another enlarged view of an alternative cross-sectional profile of the conduit;

FIG. 8 is a cross-sectional view of the conduit of FIG. 3 including a fluid cooling device;

FIG. 9 is another cross-sectional view of the conduit of FIG. 3 including another fluid cooling device; and

FIG. 10 illustrates a cross-sectional view of another conduit in accordance with aspects of the disclosure.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

Aspects of the disclosure include apparatus for producing glass ribbon from a quantity of molten glass. The glass ribbon may then be separated into glass sheets that may be used in a wide variety of applications. For instance, glass sheets produced from the glass ribbon may, for example, be used in display applications. In particular examples, the glass sheets may be used to produce liquid crystal displays (LCDs), electrophoretic displays (EPD), organic light emitting diode displays (OLEDs), plasma display panels (PDPs), or other display devices.

Glass ribbons may be fabricated by a variety of apparatus for producing glass ribbon in accordance with the disclosure such as slot draw, float, down-draw, fusion down-draw, or up-draw. Each apparatus can include a melting vessel configured to melt a batch of material into a quantity of molten glass. Each apparatus further includes at least a first conditioning station positioned downstream from the melting vessel and a second conditioning station positioned downstream from the first conditioning station. Each apparatus includes a cooling conduit operably connecting the first conditioning station with the second conditioning station. In use, batch material may be melted within the melting vessel to produce a quantity of molten glass. The molten glass may then be directly introduced into a first conditioning station to condition the glass melt. The glass melt may then be conditioned within the first conditioning station and then passed to a second conditioning station by way of a cooling conduit. The cooling conduit can act to cool the glass melt passing through the interior of the conduit as the glass melt passes from the first conditioning station to the second conditioning station. The apparatus may then produce the glass ribbon from the glass melt at a location downstream from the second conditioning station. While apparatus of the disclosure may be limited to two conditioning stations and a single cooling conduit, further examples of the disclosure may include any number of conditioning stations and/or cooling conduits. For example, one or more additional conditioning stations may be positioned in series or parallel upstream from the first conditioning station and downstream from the melting vessel. In addition or alternatively, one or more condition stations may be positioned in series or parallel downstream from the second conditioning station.

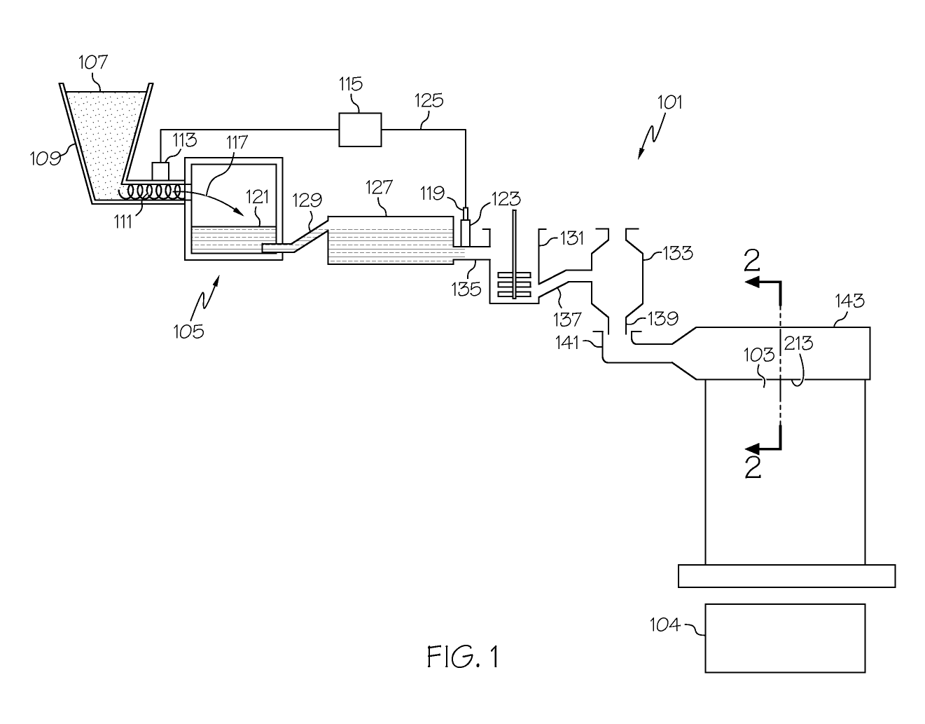

FIG. 1 illustrates a schematic view of just one example apparatus for producing glass ribbon in according to the disclosure, wherein the apparatus comprises a fusion draw apparatus 101 for fusion drawing a glass ribbon 103 for subsequent processing into glass sheets 104. The fusion draw apparatus 101 can include a melting vessel 105 configured to receive batch material 107 from a storage bin 109. The batch material 107 can be introduced by a batch delivery device 111 powered by a motor 113. An optional controller 115 can be configured to activate the motor 113 to introduce a desired amount of batch material 107 into the melting vessel 105, as indicated by arrow 117. A glass metal probe 119 can be used to measure a glass melt 121 level within a standpipe 123 and communicate the measured information to the controller 115 by way of a communication line 125.

The fusion draw apparatus 101 can also include a first conditioning station such as a fining vessel 127 (e.g., a fining tube), located downstream from the melting vessel 105 and coupled to the melting vessel 105 by way of a first connecting conduit 129. In some examples, glass melt may be gravity fed from the melting vessel 105 to the fining vessel 127 by way of the first connecting conduit 129. For instance, gravity may act to drive the glass melt to pass through an interior pathway of the first connecting conduit 129 from the melting vessel 105 to the fining vessel 127. Within the fining vessel 127, bubbles may be removed from the glass melt by various techniques. For example, the glass melt may be heated to a higher temperature to reduce viscosity of the glass melt and thereby allow gas bubbles to be released at a free surface of the glass melt within the fining vessel 127. In further examples, fining agents may be added to the glass melt to facilitate bubble formation at higher temperatures, to further provide sites for bubble formation that help a majority of the bubbles rise to the free surface for bursting an releasing the gas into the atmosphere above the free surface. At the same time, when the glass melt temperature is subsequently reduced, the same fining agent absorbs gas within the glass melt, causing remaining glass bubbles to collapse to further remove bubbles from the glass melt.

The fusion draw apparatus can further include a second conditioning station such as a mixing vessel 131 (e.g., a stir chamber) that may be located downstream from the fining vessel 127. The mixing vessel 131 can be used to provide a homogenous glass melt composition, thereby reducing or eliminating cords of inhomogeneity that may otherwise exist within the fined glass melt exiting the fining vessel. As shown, the fining vessel 127 may be coupled to the mixing vessel 131 by way of a second connecting conduit 135. In some examples, glass melt may be gravity fed from the fining vessel 127 to the mixing vessel 131 by way of the second connecting conduit 135. For instance, gravity may act to drive the glass melt to pass through an interior pathway of the second connecting conduit 135 from the fining vessel 127 to the mixing vessel 131.

The fusion draw apparatus can further include another conditioning station such as a delivery vessel 133 (e.g., a bowl) that may be located downstream from the mixing vessel 131. The delivery vessel 133 may condition the glass to be fed into a forming device. For instance, the delivery vessel 133 can act as an accumulator and/or flow controller to adjust and provide a consistent flow of glass melt to the forming vessel. As shown, the mixing vessel 131 may be coupled to the delivery vessel 133 by way of a third connecting conduit 137. In some examples, glass melt may be gravity fed from the mixing vessel 131 to the delivery vessel 133 by way of the third connecting conduit 137. For instance, gravity may act to drive the glass melt to pass through an interior pathway of the third connecting conduit 137 from the mixing vessel 131 to the delivery vessel 133.

As further illustrated, a downcomer 139 can be positioned to deliver glass melt 121 from the delivery vessel 133 to an inlet 141 of a forming vessel 143. As shown, the melting vessel 105, fining vessel 127, the mixing vessel 131, delivery vessel 133, and forming vessel 143 are examples of glass melt conditioning stations that may be located in series along the fusion draw apparatus 101.

The melting vessel 105 is typically made from a refractory material, such as refractory (e.g. ceramic) brick. The fusion draw apparatus 101 may further include components that are typically made from platinum or platinum-containing metals such as platinum-rhodium, platinum-iridium and combinations thereof, but which may also comprise such refractory metals such as molybdenum, palladium, rhenium, tantalum, titanium, tungsten, ruthenium, osmium, zirconium, and alloys thereof and/or zirconium dioxide. The platinum-containing components can include one or more of the first connecting conduit 129, the fining vessel 127 (e.g., finer tube), the second connecting conduit 135, the standpipe 123, the mixing vessel 131 (e.g., a stir chamber), the third connecting conduit 137, the delivery vessel 133 (e.g., a bowl), the downcomer 139 and the inlet 141. The forming vessel 143 is also made from a refractory material and is designed to form the glass ribbon 103.

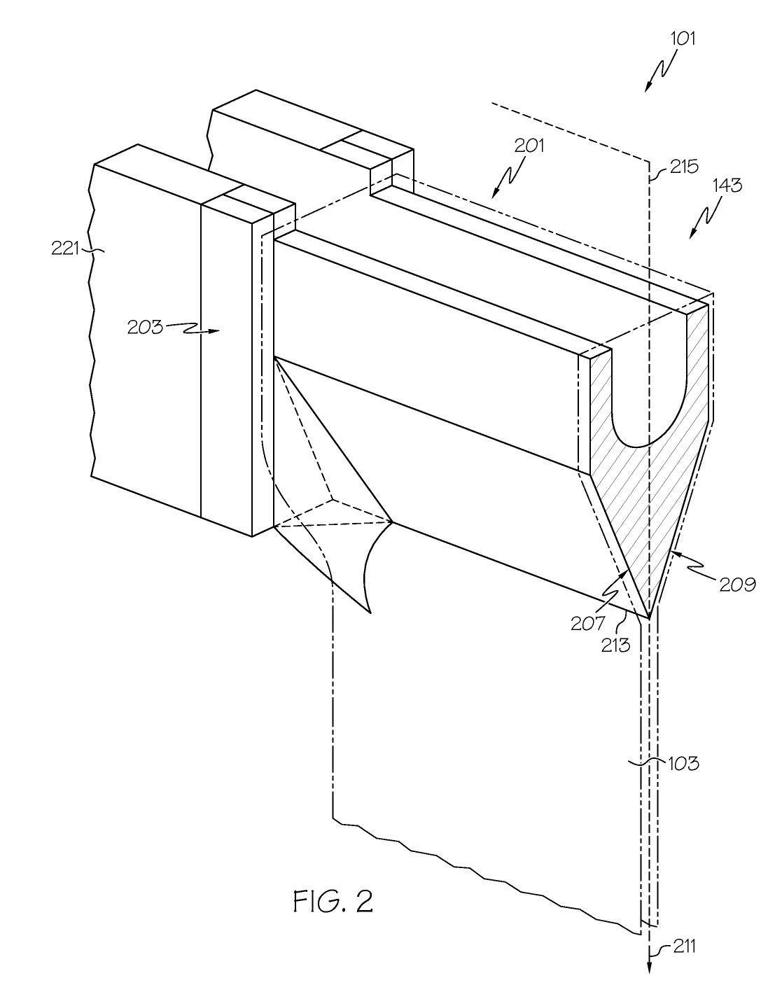

FIG. 2 is a cross-sectional perspective view of the fusion draw apparatus 101 along line 2-2 of FIG. 1. As shown, the forming vessel 143 includes a forming wedge 201 comprising a pair of downwardly inclined forming surface portions 207, 209 extending between opposed ends of the forming wedge 201. The pair of downwardly inclined forming surface portions 207, 209 converge along a downstream direction 211 to form a root 213. A draw plane 215 extends through the root 213 wherein the glass ribbon 103 may be drawn in the downstream direction 211 along the draw plane 215. As shown, the draw plane 215 can bisect the root 213 although the draw plane 215 may extend at other orientations with respect to the root 213.

In some examples, one or more of the connecting conduits may comprise cooling conduits configured to cool the glass melt passing through an interior pathway of the cooling conduit. As such, the temperature of the glass melt entering the downstream conditioning station may be less than the temperature of the glass melt exiting the upstream conditioning station associated with the cooling conduit. For example, the second connecting conduit 135 may comprise a cooling conduit, wherein the glass melt is cooled between the fining vessel 127 and the mixing vessel 131. As such, the temperature exiting the fining vessel 127 may be lowered by the second connecting conduit 135 as the glass melt passes through the interior pathway of the second connecting conduit 135 before being introduced at the lower temperature to the mixing vessel 131. Lowering the temperature of the glass melt exiting the finer can help the fining agent collapse gas bubbles within the glass melt as the fining agent absorbs gas at the lower temperature.

In addition or alternatively, the third connecting conduit 137 may comprise a cooling conduit, wherein the glass melt is cooled between the mixing vessel 131 and the delivery vessel 133. As such, the temperature exiting the mixing vessel 131 may be lowered by the third connecting conduit 137 as the glass melt passes through the interior pathway of the third connecting conduit 137 before being introduced at the lower temperature to the delivery vessel 133. Lowering the temperature of the glass melt exiting the mixing vessel 131 can help the glass melt approach a desired temperature for forming the glass ribbon.

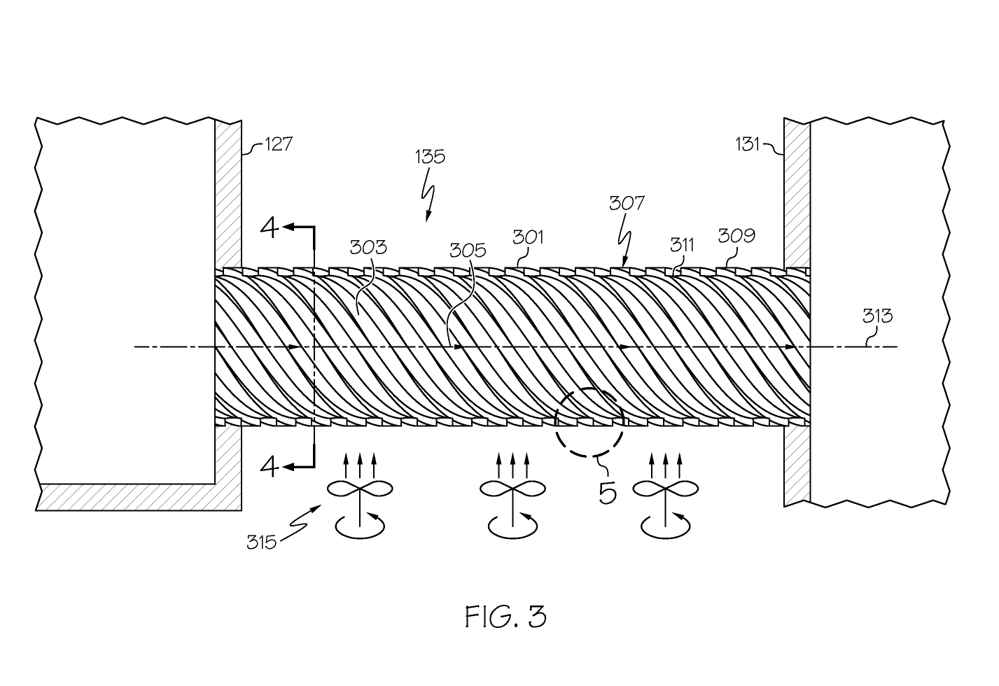

An apparatus for producing glass ribbon of the disclosure provide one or more cooling conduits operably connecting a first conditioning station with a second conditioning station, for example, as discussed above. For example, as discussed above, and as shown in FIG. 3, the cooling conduit can comprise the second connecting conduit 135 operably connecting the fining vessel 127 with the mixing vessel 131. In addition, or alternatively, as discussed above, and as shown in FIG. 10, the cooling conduit can comprise the third connecting conduit 137 operably connecting the mixing vessel 131 with the delivery vessel 133. Although not shown, in addition or alternatively, cooling conduits may be provided to connect various conditioning stations of apparatus for producing glass ribbon.

Cooling conduits will now be described with reference to FIGS. 3-9 with the describing example features of the second connecting conduit 135 with the understanding that similar or identical features may be provided with the third connecting conduit 137 or other cooling conduit of the apparatus for producing glass ribbon.

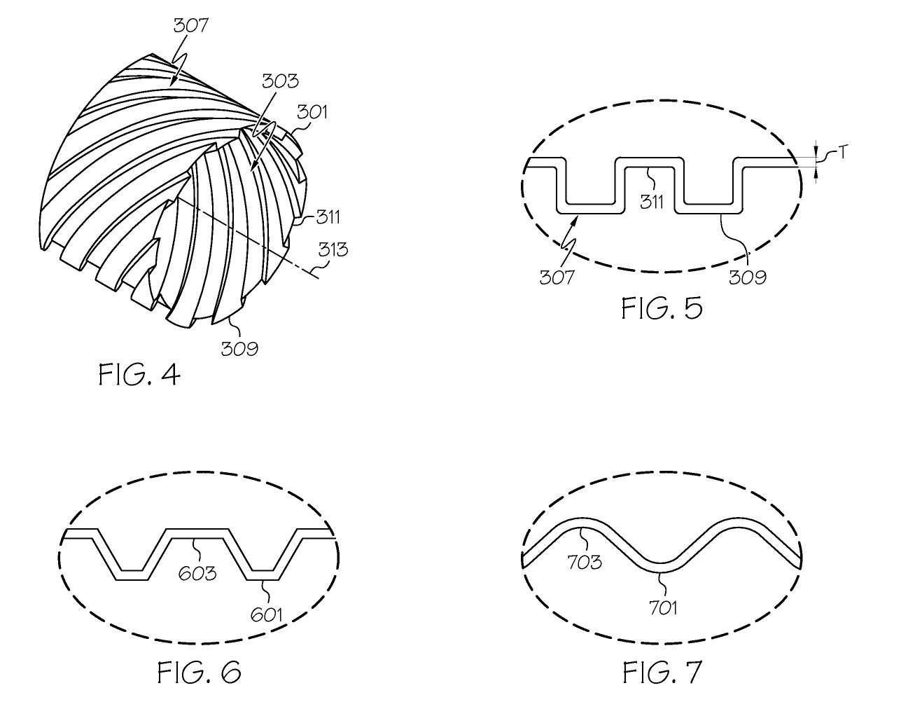

As shown in FIGS. 3 and 4, the cooling conduit includes a peripheral wall 301 comprising platinum. In one example, the peripheral wall 301 comprises platinum or platinum-containing metals such as platinum-rhodium, platinum-iridium and combinations thereof. The cooling conduit defines an interior pathway 303 configured to provide a travel path 305 for the quantity of molten glass traveling from the first conditioning station to the second conditioning station. The peripheral wall 301 includes an outer surface 307 defining a plurality of elongated radial peaks 309 spaced apart by a plurality of elongated radial valleys 311. The elongated radial peaks 309 and elongated radial valleys 311 are helically wound along an elongated axis 313 of the cooling conduit. Helical windings may be provided in a wide variety of pitches and/or with other characteristics depending on the particular application

The helical winding of the radial peaks and elongated radial valleys provides the cooling conduit with significant benefits. For example, the helical winding of the radial peaks and elongated radial valleys increases the structural strength of the cooling conduit. As such, the cooling conduit may be made with a reduced wall thickness, thereby saving significant cost associated with fabricating the conduit from platinum or platinum-containing metals. In one example, the thickness “T” of the peripheral wall 301 of the cooling conduit can be reduced to a range of from about 500 microns to about 800 microns, such as from about 600 microns to about 700 microns. Still further the thickness “T” may be provided within the 500-800 micron (e.g., 600 to 700 micron) range throughout the cooling conduit. As such, in some examples, the interior pathway 303 includes the thickness “T” defining the plurality of elongated radial peaks 309 and elongated radial valleys 311 as shown in FIGS. 3-10. Furthermore, the increased strength provided by the helical windings of radial peaks and elongated radial valleys can allow the cooling conduit to be self-supporting without the requirement of being encapsulated by a supportive refractory encasement. As such, heat convection may involve transferring heat from the glass melt through the platinum or platinum-containing metal without resistance from the refractory encasement. For example, the cooling fluid may be forced to directly contact the outer surface 307 of the peripheral wall 301, wherein enhanced heat transfer is enjoyed by the relatively low resistance to heat transfer of the platinum or platinum containing metals. Moreover, the helical windings of radial peaks and valleys can provide more efficient cooling, thereby allowing enhanced cooling or more cooling over a shorter length of the cooling tube. As such, reduced length cooling conduits may be provided, thereby saving significant material costs that would otherwise be required to produce relatively long cooling conduits. Moreover, as the cooling efficiency is increased, the glass flow may be increased through the cooling tube while still obtaining sufficient cooling. As such, advantages may be achieved by increased glass ribbon production from increased molten glass flow through the apparatus that is permitted by the efficient cooling tubes of the disclosure.

The elongated radial peaks and elongated radial valleys may have a wide range of configurations in accordance with aspects of the disclosure. For instance, as shown, FIG. 5, the elongated radial peaks 309 and the elongated radial valleys 311 define a stepped peripheral contour circumscribing the elongated axis of the cooling conduit. As shown, the steps can optionally include substantially flat tops and substantially flat bottoms with side portions that are oriented at approximate 90° angles relative to one another. In some examples, the corners may be rounded to reduce stress points.

FIG. 6 illustrates another example wherein the elongated radial peaks 601 and the elongated radial valleys 603 that also define a stepped peripheral contour that are helically wound around the elongated axis and circumscribe the elongated axis in a manner similar or identical to the helical configuration shown in FIG. 4. The radial peaks 601 and radial valleys 603 are substantially flat, however, the side portions are oriented at angles to increase the angles at the corners. Increasing the angles may be desirable, for example, to further increase the structural integrity of the cooling conduit.

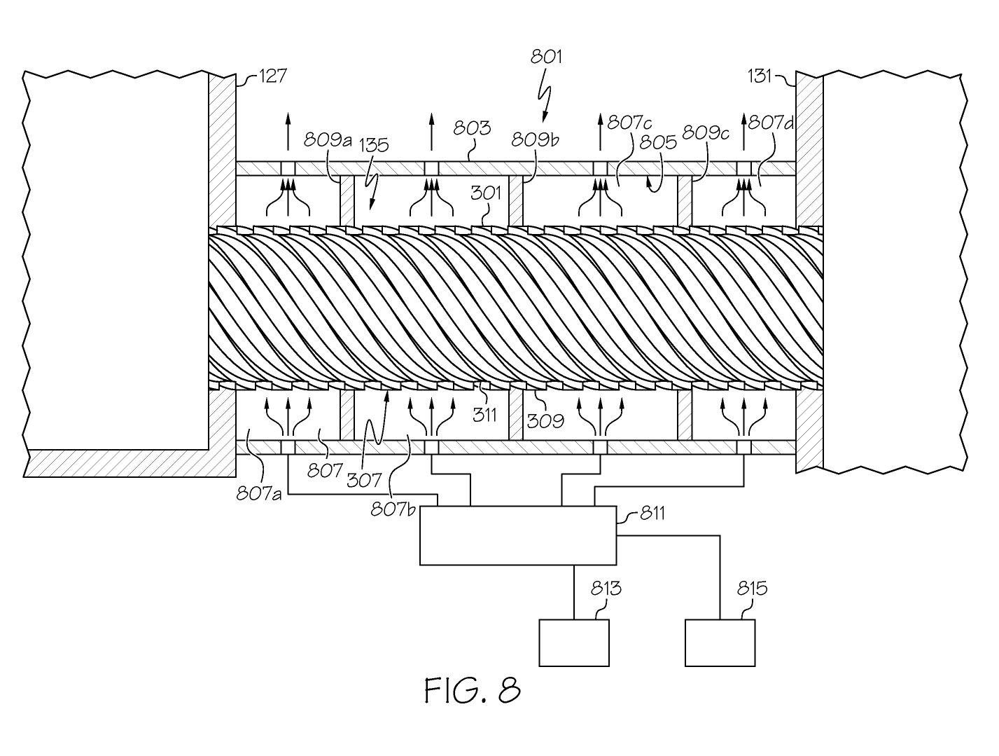

FIG. 7 illustrates another example wherein the elongated radial peaks 701 and the elongated radial valleys 703 that define a curvilinear peripheral contour, such as the illustrated sinusoidal peripheral contour, circumscribing the elongated axis of the cooling conduit in a manner similar or identical to the helical configuration shown in FIG. 4. The curvilinear nature of the radial peaks 701 and radial valleys 703 can still further increase the structural integrity of the cooling conduit by removing stress points that may otherwise occur at the corners.

In some examples, the apparatus further comprises a fluid cooling device configured to force cooling fluid over the outer surface of the peripheral wall. For example, the cooling device may optionally be provided with respect to the second connecting conduit 135, the third connecting conduit 137 and/or other connecting conduits acting as cooling conduits. In one example, as shown in FIG. 8, a fluid cooling device 801 includes a housing 803 configured to circumscribe the outer surface 307 of the peripheral wall 301 of the cooling conduit. FIG. 8 illustrates one example where an inner surface 805 of the housing is spaced from the elongated radial peaks 309 and the elongated radial valleys 311 of the outer surface 307. In such an example, cooling fluid may be introduced into an interstitial circumferential space 807 defined between the outer surface 307 of the peripheral wall 301 and the inner surface 805 of the housing 803. Providing the housing can allow for the cooling fluid to comprise air or other fluids such as nitrogen, argon, helium, CO₂ or similar gas or combinations. For instance, a cooling fluid may be used that has reduced oxygen levels to inhibit oxidation of the outer surface 307 of the cooling conduit due to the platinum component of the conduit wall. In addition or alternatively, the outer surface 307 of the peripheral wall may be treated with a plasma spray zirconia coating or other coating that inhibits interaction of platinum with the cooling fluid.

As further illustrated in FIG. 8, aspects of the disclosure may provide for selected temperature control along the length of the cooling conduit. For example, as shown in FIG. 8, peripheral isolation members 809a, 809b, 809c may divide the circumferential space 807 into zones 807a, 807b, 807c, 807d. As such, different preselected flow characteristics (e.g., flow rate, type of gas, gas temperature, etc.) may be selectively introduced into each of the zones 807a-d to facilitate the desired heat transfer rate at each zone along the length of the cooling conduit. As schematically illustrated, the fluid cooling device 801 may optionally include a fluid manifold 811 that may be operated by a controller 813 to selectively provide each zone 807a-d with cooling fluid from a cooling fluid source 815.

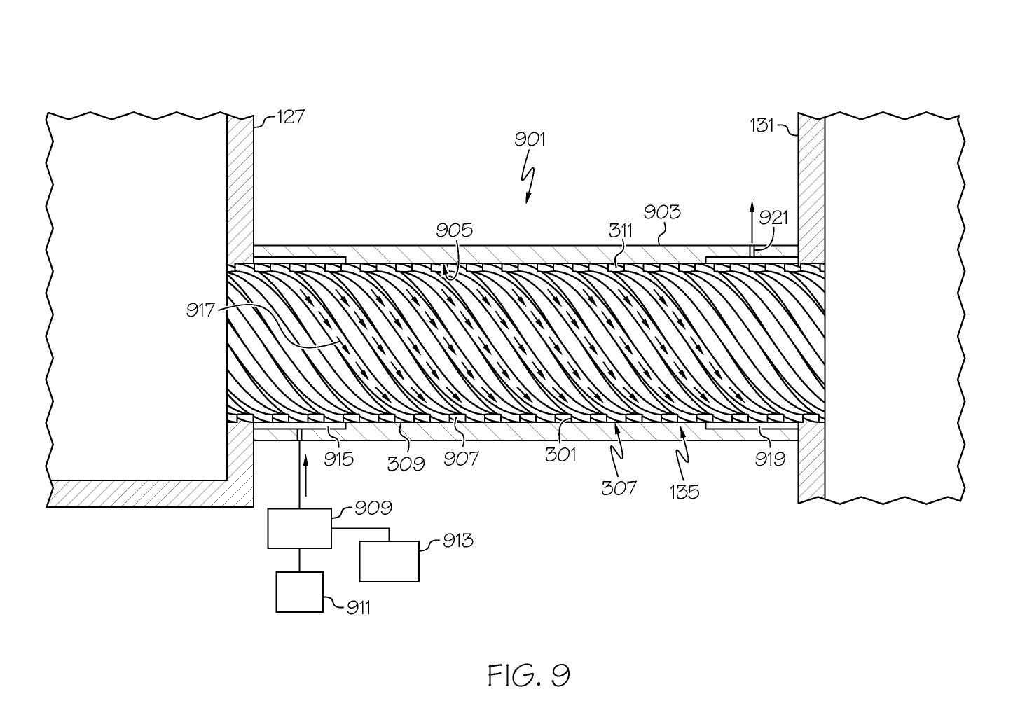

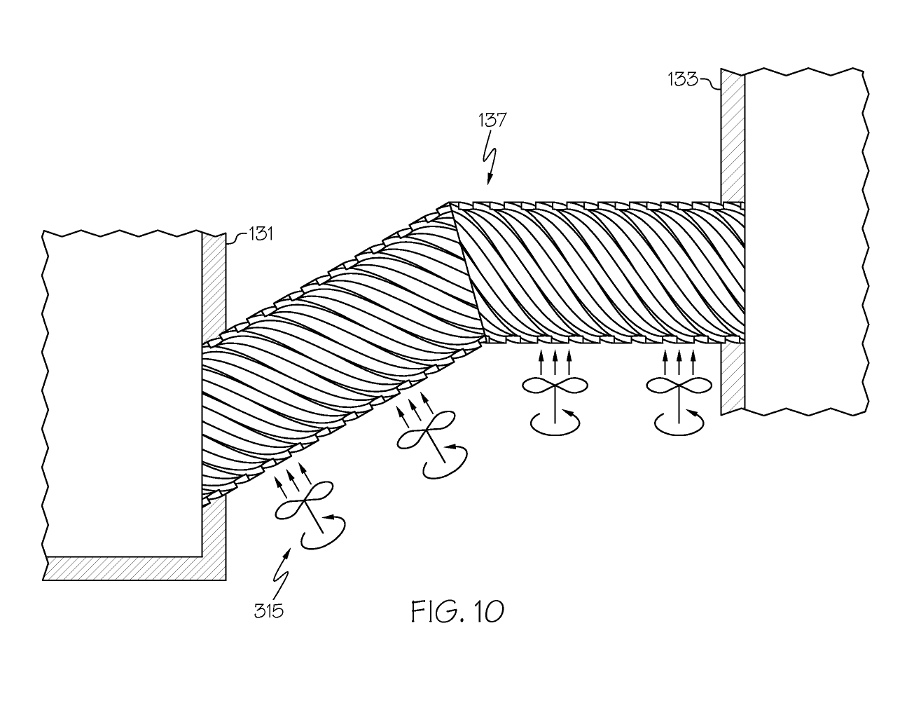

FIG. 9 illustrates another example fluid cooling device 901 including a housing 903 configured to circumscribe the outer surface 307 of the peripheral wall 301 of the cooling conduit. FIG. 9 illustrates one example where an inner surface 905 of the housing contacts the radial peaks 309 wherein helical fluid cooling paths 907 are defined by the elongated radial valleys 311 being capped by the inner surface 905 of the housing 903. As such, helical cooling paths may be designed to allow helical movement of the cooling fluid about the elongated axis 313 of the cooling conduit. Helical movement of the cooling fluid can allow more even cooling of the molten glass about the periphery of the molten glass path independent of the radial position of the cooling conduit. Moreover, like the cooling device 801 of FIG. 8, providing the housing 903 can allow for the cooling fluid to comprise air or other fluids such as nitrogen, argon, helium, CO₂ or similar gas or combinations. For instance, a cooling fluid may be used that has reduced oxygen levels to inhibit oxidation of the outer surface 307 of the cooling conduit due to the platinum component of the peripheral wall.

As with the example illustrated in FIG. 8, aspects of the disclosure may provide for selected temperature control along the length of the cooling conduit with the cooling device of FIG. 9. For example, each cooling zone may be provided with a fluid cooling configuration illustrated schematically in FIG. 9. As shown, the cooling configuration includes a fluid valve 909 that may be operated by a controller 911 to selectively provide a circumferential inlet interstitial area 915 with cooling fluid from a cooling fluid source 913. The cooling fluid may then be forced to travel along corresponding helical paths 917 along the length of the cooling conduit until the cooling fluid reaches a circumferential exit interstitial area 919 and then exiting an opening 921 through the housing 903.

Methods of producing the glass ribbon 103 will now be discussed. The method includes the step of providing the first conditioning station positioned downstream from the melting vessel, the second conditioning station positioned downstream from the first conditioning station, and the cooling conduit operably connecting the first conditioning station with the second conditioning station. The cooling conduit includes a peripheral wall comprising platinum and defining an interior pathway and an outer surface of the peripheral wall defines a plurality of elongated radial peaks spaced apart by a plurality of elongated radial valleys. The elongated radial peaks and elongated radial valleys are helically wound along an elongated axis of the cooling conduit. In one example, the method of providing may include assembling the apparatus and/or fabricating the cooling conduit. Alternatively, the step of providing may simply include the step of approaching a previously assembled and fabricated apparatus.

As shown in FIG. 1, the method further includes the step of melting batch material 107 with the melting vessel 105 to produce the quantity of molten glass 121. The method further includes the step of passing the molten glass 121 through the interior pathway 303 of the cooling conduit to pass the molten glass from the first conditioning station to the second conditioning station. For instance, the step can include passing molten glass 121 through the interior pathway 303 the cooling conduit comprising the second connecting conduit 135 from the first conditioning station comprising the fining vessel 127 to the second conditioning station comprising the mixing vessel 131. In another example, the step can include passing molten glass 121 through the interior pathway 303 of the cooling conduit comprising the third connecting conduit 137 from the first conditioning station comprising the mixing vessel 131 to the second conditioning station comprising the delivery vessel 133. The method can then include the step of fluid cooling the outer surface of the peripheral wall of the cooling conduit to cool the quantity of molten glass during the step of passing the molten glass through the interior pathway of the cooling conduit.

In one example, the method can include forcing cooling fluid over the outer surface of the peripheral wall of the cooling conduit with a fluid cooling device. As shown in FIGS. 3 and 10, the cooling device may simply comprise blowers 315 with fan blades configured to blow fluid (e.g., air) over the peripheral wall of the cooling conduit. Alternatively, as shown in FIGS. 8 and 9, the cooling device may include the previously-described housing 803, 903 that circumscribes the outer surface 307 of the peripheral wall 301 of the cooling conduit. FIG. 8 illustrated an example wherein the housing 803 is provided with the inner surface 805 that is spaced from the elongated radial peaks 309 and the elongated radial valleys 311 of the outer surface 307. Alternatively, FIG. 9 illustrates another housing 903 further comprising the step of forming helical fluid cooling paths 907 by capping the elongated radial valleys 311 with an inner surface 905 of the housing 903, wherein the method includes the step of forcing cooling fluid through the helical fluid cooling paths to cool the quantity of molten glass.

As shown in FIG. 8, the method can further include the step of independently cooling a plurality of cooling zones 807a-d located along the axis of the cooling conduit at different cooling rates. Similar methodology may also be optionally provided with the cooling device of FIG. 3 or 9.

It will be apparent to those skilled in the art that various modifications and variations can be made without departing from the spirit and scope of the claimed invention.

What is claimed is:

1. An apparatus for producing glass ribbon comprising:
a melting vessel configured to melt a batch of material into a quantity of molten glass;
at least a first conditioning station positioned downstream from the melting vessel and a second conditioning station positioned downstream from the first conditioning station;
a cooling conduit operably connecting the first conditioning station with the second conditioning station, wherein the cooling conduit includes a peripheral wall comprising platinum and defining an interior pathway configured to provide a travel path for the quantity of molten glass traveling from the first conditioning station to the second conditioning station, and wherein the peripheral wall includes an outer surface defining a plurality of elongated radial peaks spaced apart by a plurality of elongated radial valleys, with the elongated radial peaks and elongated radial valleys helically wound along an elongated axis of the cooling conduit.

2. The apparatus of claim 1, wherein the peripheral wall defining the interior pathway includes a thickness defining the plurality of elongated radial peaks and elongated radial valleys.

3. The apparatus of claim 2, wherein the thickness of the peripheral wall is within a range of from about 500 microns to about 800 microns.

4. The apparatus of claim 1, wherein the peripheral wall includes a thickness within a range of from about 500 microns to about 800 microns.

5. The apparatus of claim 1, wherein the elongated radial peaks and the elongated radial valleys define a stepped peripheral contour circumscribing the elongated axis of the cooling conduit.

6. The apparatus of claim 1, wherein the elongated radial peaks and the elongated radial valleys define a curvilinear peripheral contour circumscribing the elongated axis of the cooling conduit.

7. The apparatus of claim 6, wherein the curvilinear peripheral contour comprises a sinusoidal peripheral contour.

8. The apparatus of claim 1, further comprising a fluid cooling device configured to force cooling fluid over the outer surface of the peripheral wall.

9. The apparatus of claim 8, wherein the fluid cooling device comprises a housing configured to circumscribe the outer surface of the peripheral wall of the cooling conduit.

10. The apparatus of claim 9, wherein an inner surface of the housing is spaced from the elongated radial peaks and the elongated radial valleys of the outer surface.

11. The apparatus of claim 9, wherein helical fluid cooling paths are defined by the elongated radial valleys being capped by an inner surface of the housing.

12. The apparatus of claim 8, wherein the fluid cooling device is configured to provide a plurality of independent cooling zones located along the axis of the cooling conduit.

13. A method of producing glass ribbon comprising the steps of:
(I) providing a first conditioning station positioned downstream from a melting vessel, a second conditioning station positioned downstream from the first conditioning station, and a cooling conduit operably connecting the first conditioning station with the second conditioning station, wherein the cooling conduit includes a peripheral wall comprising platinum and defining an interior pathway, and wherein an outer surface of the peripheral wall defines a plurality of elongated radial peaks spaced apart by a plurality of elongated radial valleys, with the elongated radial peaks and elongated radial valleys helically wound along an elongated axis of the cooling conduit;
(II) melting batch material with the melting vessel to produce a quantity of molten glass;
(III) passing the molten glass through the interior pathway of the cooling conduit to pass the molten glass from the first conditioning station to the second conditioning station; and
(IV) fluid cooling the outer surface of the peripheral wall of the cooling conduit to cool the quantity of molten glass during step (III).

14. The method of claim 13, wherein step (IV) includes forcing cooling fluid over the outer surface of the peripheral wall of the cooling conduit with a fluid cooling device.

15. The method of claim 14, further comprising providing the fluid cooling device with a housing that circumscribes the outer surface of the peripheral wall of the cooling conduit.

16. The method of claim 15, wherein the housing is provided with an inner surface that is spaced from the elongated radial peaks and the elongated radial valleys of the outer surface.

17. The method of claim 15, further comprising the step of forming helical fluid cooling paths by capping the elongated radial valleys with an inner surface of the housing, wherein step (IV) includes forcing cooling fluid through the helical fluid cooling paths to cool the quantity of molten glass.

18. The method of claim 14, further comprising independently cooling a plurality of cooling zones located along the axis of the cooling conduit at different cooling rates.

19. The method of claim 13, wherein the peripheral wall of the cooling conduit is provided with a thickness within a range of from about 500 microns to about 800 microns.

20. The method of claim 13, wherein the elongated radial peaks and the elongated radial valleys define peripheral cross-sectional contour circumscribing the elongated axis of the cooling conduit with a shape selected from the group consisting of: a stepped shape and a curvilinear shape.
